(19) United States
(12) Patent Application Publication
(10) Pub. No.: US 2011/0099398 A1
(43) Pub. Date: Apr. 28, 2011

(54) INTEGRATED CIRCUIT AND ELECTRONIC APPARATUS

(75) Inventor: Masahiro HOUSHAKU, Tokyo (JP)

(73) Assignee: PANASONIC CORPORATION, Osaka (JP)

(21) Appl. No.: 12/982,344

(22) Filed: Dec. 30, 2010

Related U.S. Application Data
(63) Continuation of application No. PCT/JP2009/002372, filed on May 28, 2009.

(30) Foreign Application Priority Data
Jul. 1, 2008 (JP) 2008-172313

(51) Int. Cl. G06F 1/32; G06F 15/76; G06F 9/00

(52) U.S. Cl. 713/320; 712/35; 712/E09.001

(57) ABSTRACT

An integrated circuit includes a main processing unit, a peripheral connection port for connecting a peripheral device, and an auxiliary processing unit configured to control the peripheral connection port and to perform controlling of interruption and transmission of data from the peripheral device connected to the peripheral connection port instead of the main processing unit. The main processing section and the peripheral connection portion are connected to each other with an inner bus. The main processing unit uses a memory resource provided in the auxiliary processing unit as a part of an inner memory space of the main processing unit.

### BACKGROUND

The present invention relates to an integrated circuit in which a main processing unit and a peripheral connection port to be connected to a peripheral device are connected to each other with an internal bus, and an electronic apparatus.

With the rapid progress in recent digital technologies and compression-expansion technologies of video data or audio data, and micronization of semiconductor integrated circuits, audio-video apparatuses such as Digital Televisions (DTV), Digital Video Recorders (DVR), e.g., DVD recorders, mobile phones, video cameras or the like have been more sophisticated. With the sophistication, operations of the apparatuses become complicated. In addition, since miniaturization or thinning of the apparatuses is required, an area between a frame and a display in each of the apparatuses is reduced irrespective of a size thereof. For this reason, many operation buttons or the like as input interfaces could not be arranged on each of the apparatuses.

Thus, since input interfaces such as buttons, keys or the like which can be intuitively operated by a user, cannot be sufficiently arranged on an apparatus, it is expected that a guide function or a support function for introducing a way of operating or a necessary function to a user, and a man-machine interface that does not require a button or a key, are achieved.

In order to achieve the above requirement, for example, a touch panel is provided on a display as a man-machine interface without the use of a button or a key. In stead of a button for inputting a direction such as a back, forth, upper or lower direction, a switching operation is performed in such a manner that an operation is associated with inclination of an electronic device, a camera provided in the device is made in an idle state or a switch-off state when a lens of the camera is oriented to face downward, or the camera is activated when the camera is placed in a horizontal orientation as if it is in a posture for capturing a subject. In addition, since a wireless headphone receives audio data transmitted in a wireless communication, a speaker provided on an apparatus is removed from the apparatus.

As described above, compounding or totalizing of various functions in an electronic apparatus is required and also miniaturizing or thinning of the apparatus is required. Since miniaturizing or thinning of an apparatus is achieved, there is not a sufficient space for arranging an input interface such as a button, a key or the like in the apparatus. For this reason, use of a high performance Graphical User Interface (GUI) or an intelligent man-machine interface is expected.

### SUMMARY

A purpose of the invention is to provide an integrated circuit suitable for a multifunctional electronic apparatus to which a peripheral device as an interface is to be connected.

According to the invention, it is provided that an integrated circuit comprising: a main processing unit; a peripheral connection port for connecting a peripheral device, the main processing section and the peripheral connection portion being connected to each other with an inner bus; and an auxiliary processing unit configured to control the peripheral connection port and to perform controlling of interruption and transmission of data from the peripheral device connected to the peripheral connection port instead of the main processing unit, wherein the main processing unit uses a memory resource provided in the auxiliary processing unit as a part of an inner memory space of the main processing unit.

According to the invention, it is provided that an integrated circuit comprising: a main processing unit configured to perform both of controlling of an entirety of a system and processing of a medium; and an auxiliary processing unit configured to perform controlling of interruption and transmission of data from a peripheral device connected to the main processing unit, wherein the auxiliary processing unit has a data storing unit which stores data transmitted from the peripheral device, and performs intermediate processing of the data stored in the data storing unit so as to collectively transmit the data to an external memory.

In the integrated circuit, the data storing unit provided in the auxiliary processing unit is accessed by the main processing unit as a part of an inner memory of the main processing unit, the auxiliary processing unit has a flag register which notifies the main processing unit of a fact that updating is made in a part of data read by the main processing unit when an operation in response to a write access from the auxiliary processing unit is waited, in a case where a read access from the main processing unit and the write access from the auxiliary processing unit are simultaneously made to an identical memory address of the data storing unit, and the auxiliary processing unit performs processing with respect to the main processing unit so as to coincide coherences of pieces of data read by the main processing unit during or after an operation of reading of the main processing unit.

In the integrated circuit, when the main processing unit becomes in an idle state, supplying of a clock to the main processing unit is stopped and a power supply voltage of the main processing unit is lowered. While the main processing unit is in the idle state, the auxiliary processing unit performs processing of interruption or inputting of data from the peripheral device, or outputting of data to the peripheral device without using the main processing unit.

In the integrated circuit, the auxiliary processing unit operates at an operating frequency equal to or less than an operating frequency of the main processing unit or operates in an asynchronous mode.

In the integrated circuit, the operating frequency of the auxiliary processing unit is changed by each processing mode or each operating condition, and the auxiliary processing unit operates in an asynchronous mode.

In the integrated circuit, the auxiliary processing unit operates in the asynchronous mode while the main processing unit is in the idle state.

In the integrated circuit, data input from the peripheral device is fetched by the auxiliary processing unit, the auxiliary processing unit compares the fetched data with data that was fetched in the past and stored in the data storing unit, when a difference in amounts of the data is equal to or less than a predetermined value, the fetched data is not stored in the data storing unit, and when the difference in amounts of the data is greater than the predetermined value, the fetched data is stored in the data storing unit.

In the integrated circuit, when a frequency of fetching data from the peripheral device is greater than a predetermined value, the auxiliary processing unit stepwise increases the operating frequency, and when a size of the stored data of the data storing unit exceeds a predetermined value, the auxiliary processing unit collectively transmits the data to an external memory and notifies the main processing unit of a fact that the data is transmitted to the external memory.

According to the invention, it is provided that an electronic apparatus includes the integrated circuit to which an external device is connected.

In accordance with the invention, it is possible to achieve a high performance graphical user interface or an intelligent man-machine interface and a user support function corresponding to a time, place, condition or the like in which an electronic apparatus is used, and to improve an operability or usability of a complicated electronic apparatus.

In addition, by achieving a miniaturized apparatus having a keyless or buttonless design appearance, an entirety of one face of the apparatus is possibly formed of a display device so that it is possible to achieve the apparatus excellent in a design property.

Further, in a case where a peripheral device is connected to the integrated circuit, processing of signals in low speed bus communication or frequent processing of interruption can be efficiently performed without lowering a processing efficiency of a main processing unit nor causing deterioration of a band width performance of a bus connecting an external memory to the main processing unit.

Moreover, while an operating frequency of the main processing unit is more and more increased with rising of the performance, the high performance main processing unit is made to be offloaded from the processing of interruption or processing of low speed bus control so that reduction of power consumption can be achieved, and a leak current which may be a problem in processing of a micronization can be reduced by processing of controlling a clock or a power supply in association with processing of a standby control by the auxiliary processing unit.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing an inner structure of a related integrated circuit for processing audio and video and a peripheral structure thereof;

FIG. 2 is a block diagram showing an inner structure of an integrated circuit for processing audio and video and a peripheral structure thereof according to an embodiment of the invention;

FIG. 3 is a block diagram showing an inner structure of each of a microcomputer block and a sub-computer block, and peripheral structures thereof; and

FIG. 4 is a block diagram showing the inner structure of the sub-computer block and the peripheral structure thereof.

### DETAILED DESCRIPTION OF EXEMPLARY EMBODIMENTS

An embodiment of the invention is described below with reference to drawings. An integrated circuit for processing audio and video can be adapted to a server system electronic apparatus such as a Digital Television (DTV), a Digital Video Recorder (DVR) or the like, or a mobile electronic apparatus such as a mobile phone, a video camera or the like.

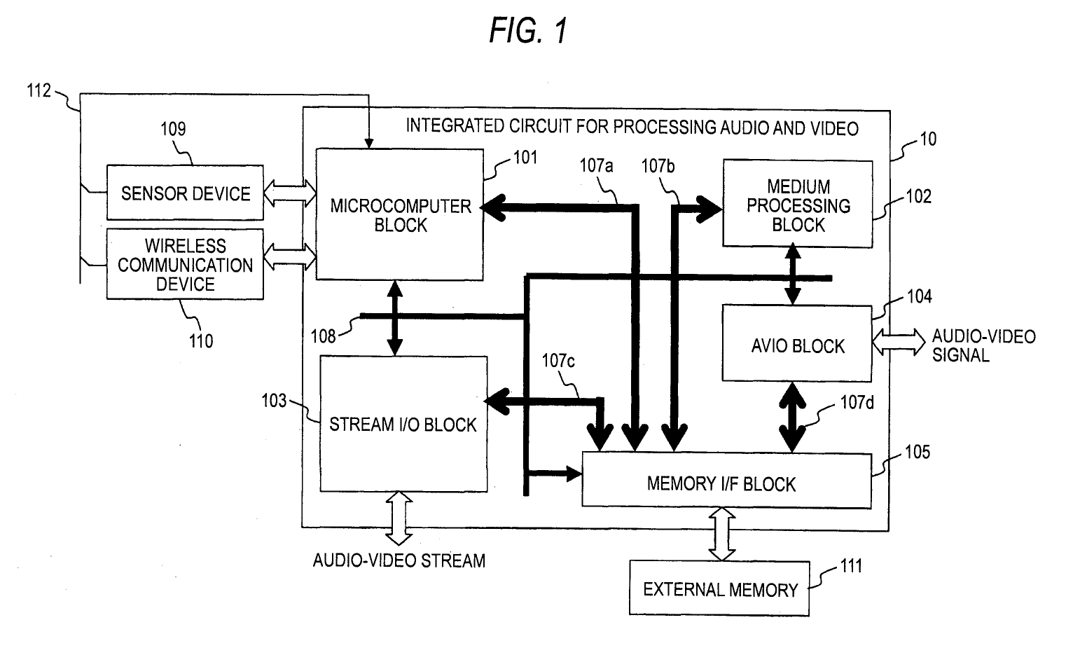

FIG. 1 is a block diagram showing an inner structure of the related integrated circuit for processing audio and video and a peripheral structure thereof. The integrated circuit 10 for processing audio and video 10 shown in FIG. 1 is a system LSI for processing stream data relating to audio or video. The system LSI includes a microcomputer block 101, a medium processing block 102, a stream I/O block 103, an AVIO (Audio Visual Input Output) block 104 and a memory I/F block 105.

The microcomputer block 101 performs versatile processing in a non real time manner and is connected to the memory I/F block 105 via a data bus 107a. The medium processing block 102 performs versatile processing in a real time manner and is connected to the memory I/F block 105 via a data bus 107b. The stream I/O block 103 performs I/O processing in a non real time manner and is connected to the memory I/F block 105 via a data bus 107c. The AVIO block 104 performs I/O processing in a real time manner and is connected to the memory I/F block 105 via a data bus 107d.

An external memory device 111 provided at the outside of the integrated circuit 10 for processing audio and video is connected to the memory I/F block 105. A sensor device 109 and a wireless communication device 110 are connected to the microcomputer block 101. The microcomputer block 101 performs I/O processing at a low speed in response to an interruption signal 112 output from the sensor device 109 or the wireless communication device 110.

It is assumed that an electronic apparatus having the integrated circuit 10 for processing audio and video is connected to a broadband network such as an internet or the like. A versatile OS (Operating Software) is mounted in a memory (not shown) of the microcomputer block 101. The integrated circuit 10 for processing audio and video performs processing of reproduction of streaming data downloaded via the internet.

In a case where the integrated circuit 10 for processing audio and video does not recognize a codec format of downloaded streaming data, codec execution software is downloaded, application software is executed on the versatile OS, and the medium processing block 102 performs versatile processing in a real time manner. However, an environment of operating the versatile OS is not always prepared in the integrated circuit 10 for processing audio and video. In order to correspond to a required specification even in the above case, an operation clock frequency is designed to be relatively high enough for allowing the microcomputer block 101 to perform processing in a real time manner.

However, the sensor device 109 and the wireless communication device 110 are connected to the microcomputer block 101 that operates at the high frequency operation clock. The sensor device 109 and the wireless communication device 110 requires the I/O processing at a speed lower than the operation clock, so that the I/O processing at the low speed may cause outstanding deterioration of the process performance of the microcomputer block 101. Further, a power consumption efficiency is also lowered.

To be specific, when the integrated circuit 10 for processing audio and video recognizes a current position of the electronic apparatus or a state where the electronic apparatus is placed, it is necessary that position detection information from a GPS or information from the wireless communication device 110 or the sensor device 109 for receiving a beacon signal generated by a neighboring electronic apparatus is constantly or highly frequently input to the microcomputer block 101. At that time, when data obtained from the sensor device 109 or the wireless communication device 110 frequently occupies the data bus 107a, a bus memory band width is lowered.

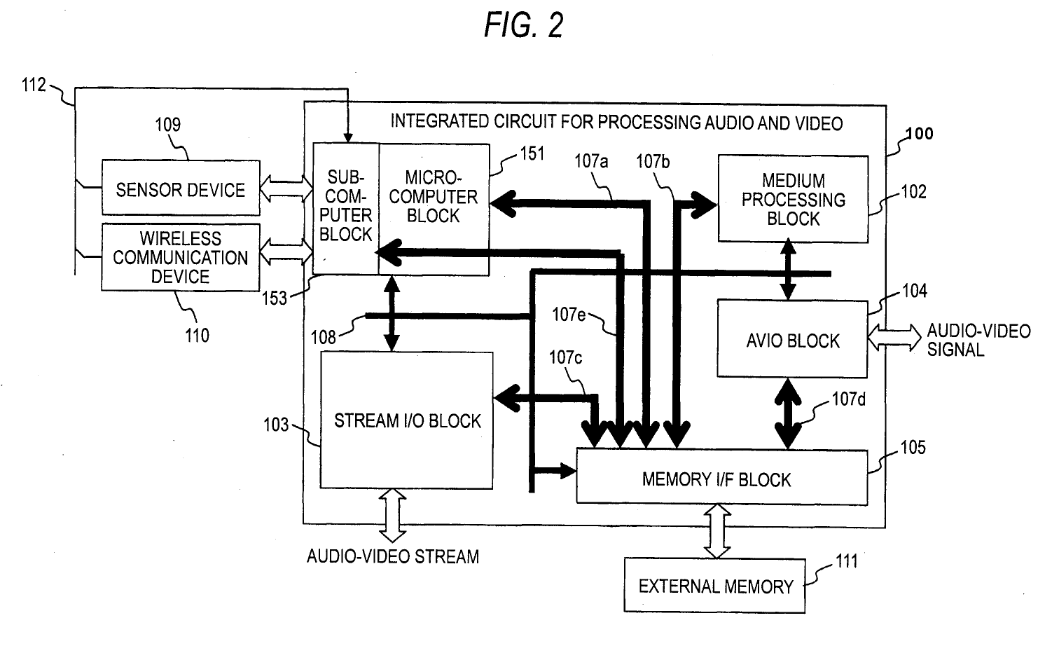

FIG. 2 is a block diagram showing an inner structure of an integrated circuit for processing audio and video and a peripheral structure thereof according to an embodiment of the invention. A different point between the integrated circuit 100 for processing audio and video shown in FIG. 2 and the integrated circuit 10 for processing audio and video shown in FIG. 1 is that the integrated circuit 100 for processing audio and video includes a microcomputer block 151 instead of the microcomputer block 101 and further includes a sub-computer block 153. The sub-computer block 153 is connected to the sensor device 109 and the wireless communication device 110. The I/O processing at the low speed performed by the microcomputer block 101 of the integrated circuit 10 for processing audio and video is performed by the sub-computer block 153. An interruption signal 112 output from the sensor device 109 or the wireless communication device 110 is input to the sub-computer block 153.

The sub-computer block 153 performs the I/O processing at the low speed with the sensor device 109 or the wireless communication device 110 in response to the interruption signal 112. The sub-computer block 153 is connected to the memory I/F block 105 via a data bus 107e.

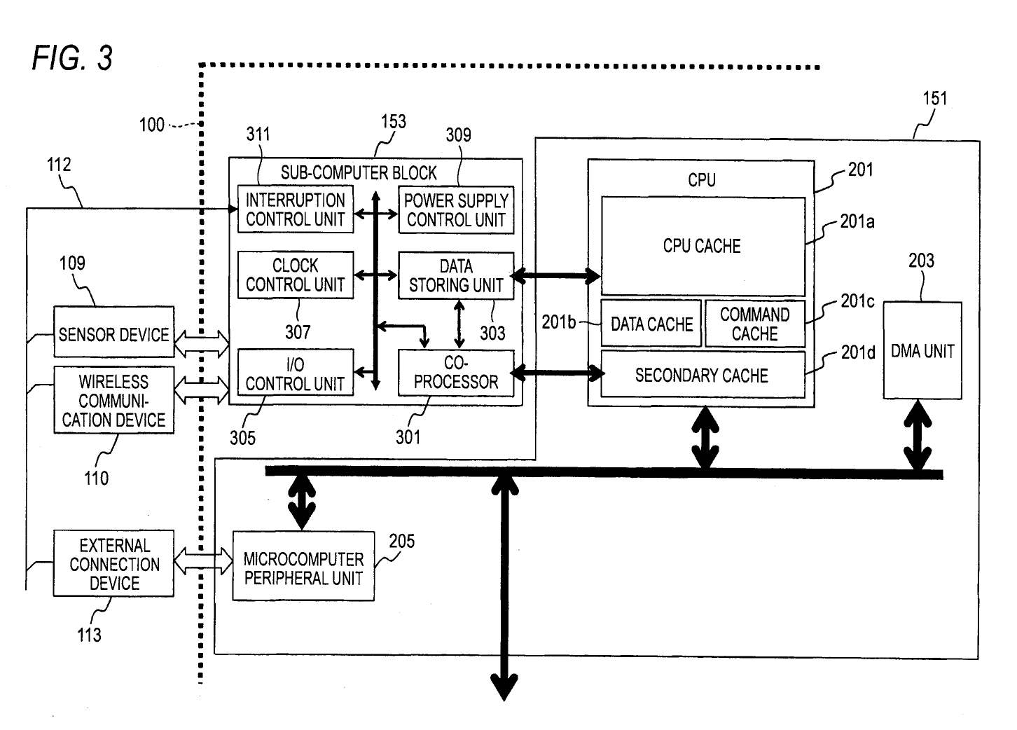

FIG. 3 is a block diagram showing an inner structure of each of the microcomputer block 151 and a sub-computer block 153, and peripheral structures thereof. The microcomputer block 151 has a CPU 201, a DMA unit 203 and a microcomputer peripheral unit 205. The sub-computer block 153 has a coprocessor 301, a data storing unit 303, an I/O control unit 305, a clock control unit 307, a power supply control unit 309 and an interruption control unit 311.

The I/O control unit 305 monitors a state of data input from the sensor device 109 or the wireless communication device 110. Only when a change amount in the state of data input being equal to or greater than a threshold value is generated, the input data is fetched to the data storing unit 303. In a condition other than the above, an operation of the sub-computer block 153 is stopped, thereby lowering the power.

In the sub-computer block 153, in a state except a constant data monitoring mode, only the interruption control unit 311 operates at an ultra-low speed clock having a frequency of, for example, 32 KHz or 12 MHz. The units other than the interruption control unit 311 become in a clock stop state. When the interruption signal 112 is input in the above state, the clock control unit 307 supplies a clock so that the coprocessor 301 starts it operation.

However, the clock signal of 12 MHz is a reference clock of a PLL. It is necessary to take a time lag of several hundred microseconds for a lock-up time (a stability wait time) or the like of the PLL until a state in which the clock can be supplied to the CPU 201 of the microcomputer block 151 or an entirety of a system LSI. Consequently, the coprocessor 301 operates at a source oscillation clock of 12 MHz when the interruption is detected. When supplying of the clock is started after stabilizing the PLL, the coprocessor 301 operates by switching the clock to a clock having a frequency which is one-severalth of the operation clock frequency of the CPU 201, for example, an operation clock frequency the same as a clock frequency of a peripheral port bus of the CPU 201, or one-second or one-fourth thereof.

In a case where the interruption signal 112 is input in a stoppage sate of the PLL and a power save mode of a power supply voltage lower than usual, the coprocessor 301 outputs a command for allowing the power supply control unit to increase the power supply voltage immediately when the interruption signal 112 is detected. However, it possibly takes several milliseconds that the power supply voltage returns to a normal voltage and becomes stable. In this case, since the power supply voltage is gradually increased, the circuit at that stage highly possibly generates an erroneous operation so that it is necessary to pay much attention to designing of the circuit.

For this reason, the coprocessor 301 is allowed to operate in an asynchronous mode in the above case. Since the coprocessor 301 in the asynchronous mode is the circuit excellent in noise-resistance, the coprocessor 301 receives the interruption signal to perform processing of a device driver such as an interruption handler or the like even during a time period of several milliseconds until the power supply voltage restores so that the coprocessor 301 can perform reprocessing by a time when the CPU 201 becomes an operable state. Thus, since the integrated circuit 100 for processing audio and video can be in a standby state in the power save mode until the interruption signal 112 is input, the integrated circuit 100 for processing audio and video can achieve low power consumption and high speed responsiveness.

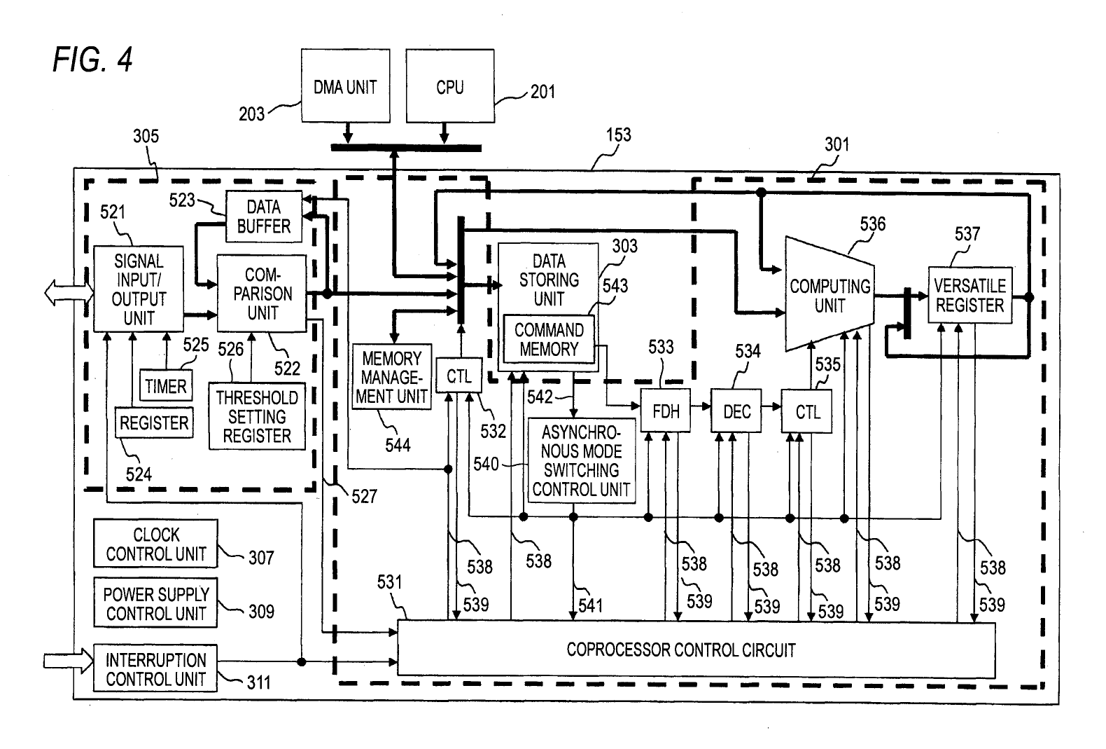

Next, the inner structure of the sub-computer block 153 is described with reference to FIG. 4. FIG. 4 is a block diagram showing the inner structure of the sub-computer block 153 and the peripheral structure thereof. Data input from the sensor device 109 or the wireless communication device 110 is received by a signal input/output unit 521 provided in the I/O control unit 305. While the signal input/output unit 521 can output data, the signal input/output unit 521 is basically and mainly used for inputting.

The signal input/output unit 521 selectively performs one of a function of fetching data in response to detection of the interruption signal 112, a function of constantly fetching or not constantly fetching data depending on a configuration which is set to a register 524 by the processor, and a function of periodically fetching data at a cycle of a value set by a timer 525. When the signal input/output unit 521 fetches data, a comparison unit 522 compares magnitudes of values of the fetched data and data stored in a data buffer 523 with each other. The data buffer 523 stores data that passes through the comparison unit 522 in the previously fetched data. When a difference between the data fetched by the signal input/output unit 521 and the data stored in the data buffer 523 is equal to or greater than a value set in a threshold setting register 526, the comparison unit 522 outputs the data fetched by the signal input/output unit 521 so as to write the data into the data buffer 523 and the data storing unit 303. At that time, the comparison unit 522 outputs a signal 527 for notifying occurrence of updating of data to a coprocessor control circuit 531 provided in the coprocessor 301.

The coprocessor 301 is set in either one of an asynchronous operation mode or a synchronous operation mode. When the coprocessor 301 is set in the asynchronous operation mode, the coprocessor control circuit 531 operates while performing handshaking, by using request signals 538 and acknowledge signals 539, with each of circuits on pipeline stages including, for example, a memory I/F control unit 532, a fetch control unit 533, a decode unit 534, a computing unit control circuit 535, a computing unit 536, a versatile register 537 and the data storing unit 303.

On the other hand, when the coprocessor 301 is set in the synchronous operation mode, an asynchronous mode switching control unit 540 provided in the coprocessor 301 outputs control signals to the circuits 531 to 537 and the data storing unit 303 so as to allow them to operate in clock synchronous states without performing the handshaking. Meanwhile, switching of the mode can be set by a register. However, when an amount of the data stored in the data storing unit 303 exceeds a threshold value and approaches just before a FULL state, the data storing unit 303 sends a mode change request signal 542 to the asynchronous mode switching control unit 540.

A command memory area 543 of the coprocessor 301 is provided in the data storing unit 303 and a command can be fetched via an exclusive bus. Further, the coprocessor 301 is provided with a memory management unit 544. The memory management unit 544 applies a coherence control to a content of the data storing unit 303 and an inner memory of the CPU 201, e.g., a secondary cache, or allows the data storing unit 303 to store information obtained from an external device so as to directly transmit the stored data to the inner memory of the CPU 201.

The integrated circuit 10 for processing audio and video shown in FIG. 1 DMA-transmits data from a microcomputer peripheral to an external memory by using the DMA unit 203, and after that, the CPU 201 accesses the external memory. However, in this embodiment, the data can be directly transmitted to the inner memory of the CPU 201 and there are many single accesses or much data in a burst size in the transmission, so that it is possible to solve a problem about a performance of a memory band width in the memory I/F block.

Regarding an operation of generating a single access from the CPU 201 to the external memory in the event of the occurrence of interruption, when the operation clock frequency of the CPU 201 is high, physical designing is not established unless a pipe line register is inserted into an external bus between the CPU 201 and the external bus in order to enhance the speed so that further deterioration of latency may occur. However, in this embodiment, since the above part is processed by the coprocessor 301, it is possible to maintain the high responsiveness even in a case where the number of kinds of man-machine interfaces is increased or the occurrence frequencies of the interruption is markedly increased. Consequently, it is possible to achieve quick movement in an electronic apparatus which is operated by a Graphical User Interface (GUI) or a sensor device having a markedly high responsiveness in such a manner that it is shook, inclined or touched.

While the invention is described in detail or by referring to a specific embodiment, it is understood by those of ordinary skill in the art that various modifications and changes can be made without departing from the sprit and scope of the invention.

This application is based on Japanese Patent Application (JP-2008-172313) filed on Jul. 1, 2008, the contents of which are incorporated herein by reference.

### INDUSTRIAL APPLICABILITY

The invention has an advantage in which the integrated circuit is useful for a system LSI for an electronic apparatus handling audio and video, particularly, a system LSI in mobile communication of a mobile phone or the like, an AVC mobile of a digital camera or the like, or an AVC server of a DTV, a DVD recorder or the like.

### DESCRIPTION OF REFERENCE NUMERALS AND SIGNS

10, 100 integrated circuit for processing audio and video
101, 151 microcomputer block
102 medium processing block
103 stream I/O block
104 AVIO block
105 memory IF block
109 sensor device
110 wireless communication device
107a-107e data bus
153 sub-computer block
201 CPU
203 DMA unit
205 microcomputer peripheral
301 coprocessor
303 data storing unit
305 I/O control unit
307 clock control unit
309 power supply control unit
311 interruption control unit

What is claimed is:

1. An integrated circuit comprising:
a main processing unit;
a peripheral connection port for connecting a peripheral device, the main processing section and the peripheral connection portion being connected to each other with an inner bus; and
an auxiliary processing unit configured to control the peripheral connection port and to perform controlling of interruption and transmission of data from the peripheral device connected to the peripheral connection port instead of the main processing unit,
wherein the main processing unit uses a memory resource provided in the auxiliary processing unit as a part of an inner memory space of the main processing unit.

2. The integrated circuit according to claim 1, wherein when the main processing unit becomes in an idle state, supplying of a clock to the main processing unit is stopped and a power supply voltage of the main processing unit is lowered; and
wherein while the main processing unit is in the idle state, the auxiliary processing unit performs processing of interruption or inputting of data from the peripheral device, or outputting of data to the peripheral device without using the main processing unit.

3. The integrated circuit according to claim 1, wherein the auxiliary processing unit operates at an operating frequency equal to or less than an operating frequency of the main processing unit or operates in an asynchronous mode.

4. The integrated circuit according to claim 3, wherein the auxiliary processing unit operates in the asynchronous mode while the main processing unit is in the idle state.

5. The integrated circuit according to claim 1, wherein the operating frequency of the auxiliary processing unit is changed by each processing mode or each operating condition; and
wherein the auxiliary processing unit operates in an asynchronous mode.

6. The integrated circuit according to claim 5, wherein the auxiliary processing unit operates in the asynchronous mode while the main processing unit is in the idle state.

7. The integrated circuit according to claim 1, wherein data input from the peripheral device is fetched by the auxiliary processing unit;
wherein the auxiliary processing unit compares the fetched data with data that was fetched in the past and stored in the data storing unit;
wherein when a difference in amounts of the data is equal to or less than a predetermined value, the fetched data is not stored in the data storing unit; and
wherein when the difference in amounts of the data is greater than the predetermined value, the fetched data is stored in the data storing unit.

8. The integrated circuit according to claim 7, wherein when a frequency of fetching data from the peripheral device is greater than a predetermined value, the auxiliary processing unit stepwise increases the operating frequency; and
wherein when a size of the stored data of the data storing unit exceeds a predetermined value, the auxiliary processing unit collectively transmits the data to an external memory and notifies the main processing unit of a fact that the data is transmitted to the external memory.

9. An electronic apparatus, comprising:
the integrated circuit according to claim 1,
wherein an external device is connected to the integrated circuit.

10. An integrated circuit comprising:
a main processing unit configured to perform both of controlling of an entirety of a system and processing of a medium; and
an auxiliary processing unit configured to perform controlling of interruption and transmission of data from a peripheral device connected to the main processing unit,
wherein the auxiliary processing unit has a data storing unit which stores data transmitted from the peripheral device, and performs intermediate processing of the data stored in the data storing unit so as to collectively transmit the data to an external memory.

11. The integrated circuit according to claim 10, wherein the data storing unit provided in the auxiliary processing unit is accessed by the main processing unit as a part of an inner memory of the main processing unit;
wherein the auxiliary processing unit has a flag register which notifies the main processing unit of a fact that updating is made in a part of data read by the main processing unit when an operation in response to a write access from the auxiliary processing unit is waited, in a case where a read access from the main processing unit and the write access from the auxiliary processing unit are simultaneously made to an identical memory address of the data storing unit; and
wherein the auxiliary processing unit performs processing with respect to the main processing unit so as to coincide coherences of pieces of data read by the main processing unit during or after an operation of reading of the main processing unit.

12. The integrated circuit according to claim 10, wherein when the main processing unit becomes in an idle state, supplying of a clock to the main processing unit is stopped and a power supply voltage of the main processing unit is lowered; and
wherein while the main processing unit is in the idle state, the auxiliary processing unit performs processing of interruption or inputting of data from the peripheral device, or outputting of data to the peripheral device without using the main processing unit.

13. The integrated circuit according to claim 10, wherein the auxiliary processing unit operates at an operating frequency equal to or less than an operating frequency of the main processing unit or operates in an asynchronous mode.

14. The integrated circuit according to claim 13, wherein the auxiliary processing unit operates in the asynchronous mode while the main processing unit is in the idle state.

15. The integrated circuit according to claim 10, wherein the operating frequency of the auxiliary processing unit is changed by each processing mode or each operating condition; and
wherein the auxiliary processing unit operates in an asynchronous mode.

16. The integrated circuit according to claim 15, wherein the auxiliary processing unit operates in the asynchronous mode while the main processing unit is in the idle state.

17. The integrated circuit according to claim 10, wherein data input from the peripheral device is fetched by the auxiliary processing unit;
wherein the auxiliary processing unit compares the fetched data with data that was fetched in the past and stored in the data storing unit;
wherein when a difference in amounts of the data is equal to or less than a predetermined value, the fetched data is not stored in the data storing unit; and
wherein when the difference in amounts of the data is greater than the predetermined value, the fetched data is stored in the data storing unit.

18. The integrated circuit according to claim 17, wherein when a frequency of fetching data from the peripheral device is greater than a predetermined value, the auxiliary processing unit stepwise increases the operating frequency; and
wherein when a size of the stored data of the data storing unit exceeds a predetermined value, the auxiliary processing unit collectively transmits the data to an external memory and notifies the main processing unit of a fact that the data is transmitted to the external memory.

19. An electronic apparatus, comprising:
the integrated circuit according to claim 10,
wherein an external device is connected to the integrated circuit.
